(19) United States
(12) Patent Application Publication
(10) Pub. No.: US 2017/0169963 A1
(43) Pub. Date: Jun. 15, 2017

(54) LIGHT SWITCH INDICATOR

(71) Applicants: JOHN SCHLICK, MENOMONEE FALLS, WI (US); MATTHIAS BOLLMUS, WAUKESHA, WI (US); MICHAEL S. ERWIN, MUKWONAGO, WI (US)

(72) Inventors: JOHN SCHLICK, MENOMONEE FALLS, WI (US); MATTHIAS BOLLMUS, WAUKESHA, WI (US); MICHAEL S. ERWIN, MUKWONAGO, WI (US)

(21) Appl. No.: 15/380,302

(22) Filed: Dec. 15, 2016

Related U.S. Application Data
(60) Provisional application No. 62/267,364, filed on Dec. 15, 2015.

(51) Int. Cl. H01H 9/16

(52) U.S. Cl. CPC H01H 9/16

(57) ABSTRACT

Three-dimensional light switch indicators and methods for making and using the indicators.

### RELATED APPLICATIONS

This application claims the benefit of co-pending provisional application Ser. No. 62/267,364 filed 15 Dec. 2016.

### BACKGROUND OF THE INVENTION

The present invention relates to indicators for light switches and other electrical outlets.

Generally, indicators for light switches and the like have been flat stickers or adhesives that are secured to a switch plate or above a light switch. Such indicators cannot be easily transferred if necessary, and do not provide tactile assistance in locating a light switch.

### SUMMARY OF THE INVENTION

The present invention is a three-dimensonal electrical switch indicator. The indicator is attached near a switch to indicate what that specific switch is used for.

The present invention is also directed towards kits that include the present switch indicators.

The present invention is further directed towards methods of producing the present switch indicators.

### BRIEF DESCRIPTION OF THE DRAWINGS

FIG. 1 s a depiction of a kit of light switch indicators according to the present invention.

FIG. 2 is a perspective view of a light switch indicator according to the present invention.

FIG. 3 is an elevation view of the light switch indicator of FIG. 2.

FIG. 4 depicts a person removing a light switch indicator from the kit shown in FIG. 1.

FIG. 5 depicts a person attaching the slight switch indicator from FIG. 4 to a light switch plate.

FIG. 6 is a rear view of a light switch indicator of the present invention.

FIG. 7 is a view of the light switch indicator of FIG. 6.

FIG. 8 depicts light switch indicators being affixed to a light switch plate.

FIGS. 9A-9F depict further arrangements of the light switch indicator shown in FIG. 1 having further shapes for the light switch indicator.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

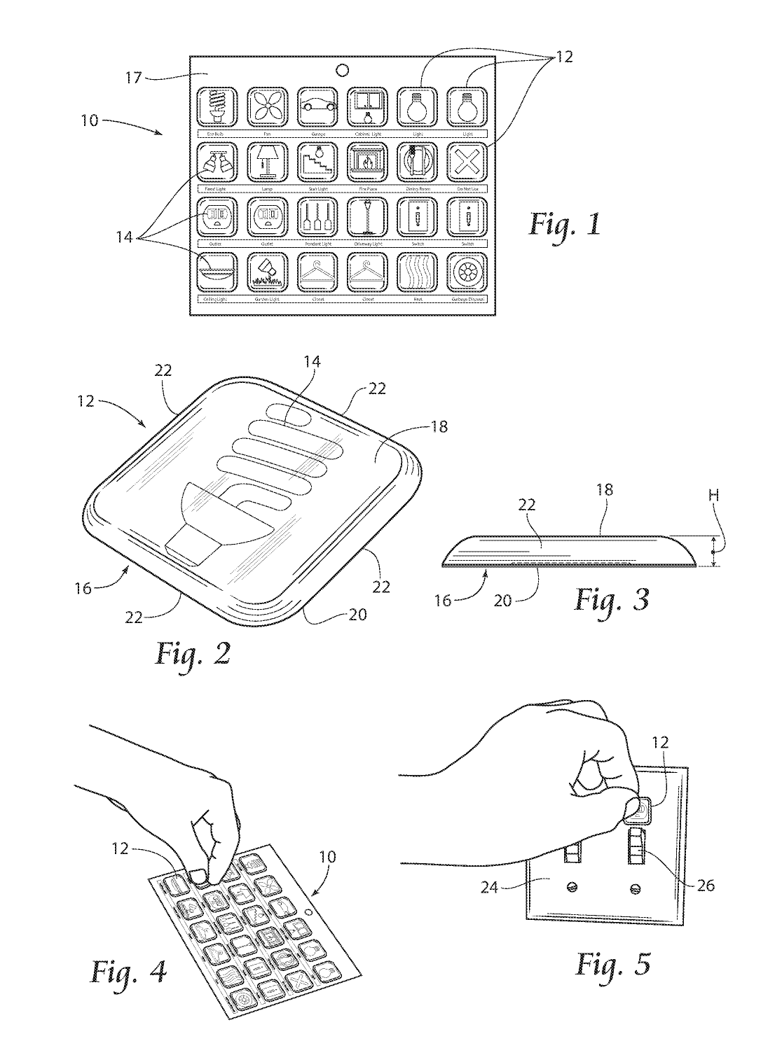

FIG. 1 depicts a kit 10 including various light switch indicators 12 according to the present invention. The light switch indicators 12 have various indicia 14 which would be correlated to various areas and place in a house or a building so that a person will quickly be able to know which light switch corresponds to a particular area or room in a house. For example, an indicia 14 of a vehicle would instruct a person that the light switch it is associated with would be used to turn on the light in the garage. Likewise, a light switch indicator 12 having a picture of a coat hanger would let someone know that a light switch was for a light in a closet.

The kit 10 shown in FIG. 1 is demonstrative of kit 10 according to the present invention. As shown, the individual light switch indicators 12 show various indicia 14 for various uses and places, such as a garbage disposal, stair lights, lamp, etc. Depending on the particular use and the particular building, e.g. a residential vs. commercial building, the kit 10 could be modified to have different light switch indicators 12 and/or more or less of a particular indicia 14 on the light switch indicators 12. The indicators 12 have an adhesive backing material 16 that allows the indicators 12 to be attached to the surface 17 of the kit 10 until a particular indicator 12 is removed from the surface for attachment to a light switch plate (see FIGS. 4 and 5).

FIGS. 2 and 3 depict an individual light switch indicator 12 having an indicia 14 of a fluorescent light bulb. The light switch indicator 12 has a top side 18 and a bottom side 20, with a height H associated with the sides 22 of the indicator 12. The height H is sufficient so that a person, when viewing the indicator 12 will view it as having three dimensions and not being only a flat surface. As shown the indicator is generally a square shape, but it would be possible that other shapes may be possible. As shown in FIG. 3, each of the sides 22 has a curve or slope from the bottom side 20 to the top side 18. The curved edges provide a smoother surface for a person when grabbing and positioning the indicator 12.

The indicia 14 shown on the indicator is preferably made by an inkjet ink process and/or a three-dimensional printer, wherein the indicia 14 is printed integrally with the substrate that forms the indicator.

FIGS. 4 and 5 demonstrate the process of placing an indicator 12 onto a light switch plate 24. An individual selects the indicator 12 that has the indicia 14 that corresponds to the particular electrical component to which a particular light switch 26 is associated with. The individual removes the indicator 12 from the kit 10 and places it on the light switch plate 24 above the particular light switch 26. The indicator could also be placed below the light switch 25.

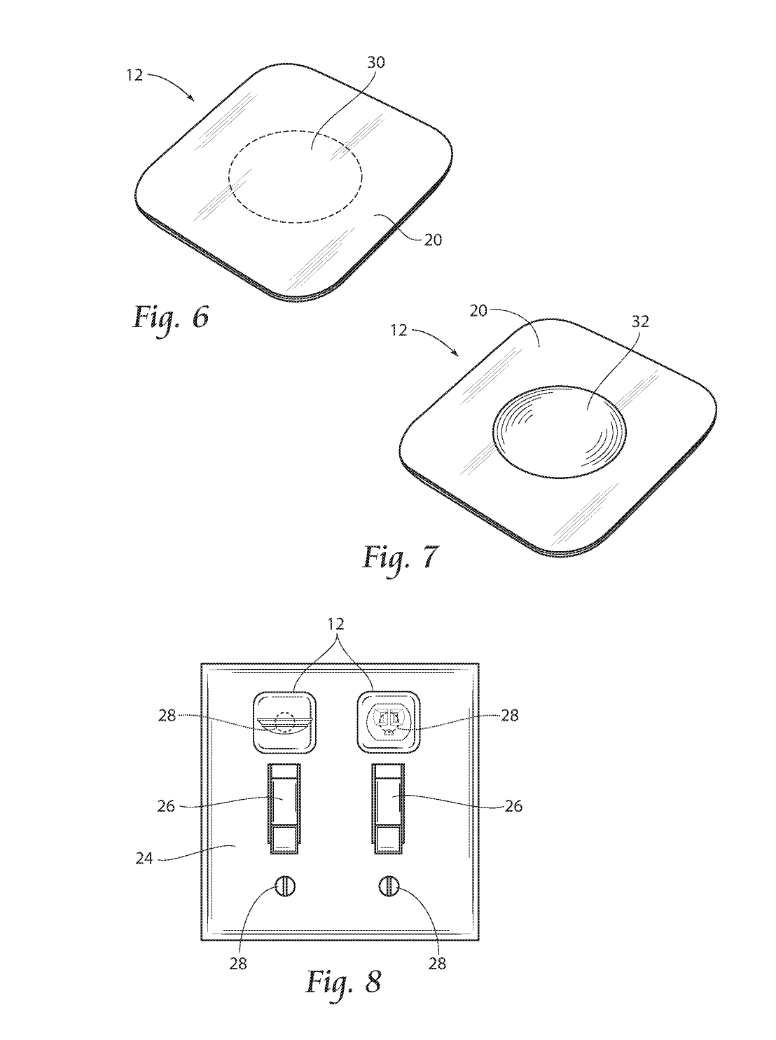

Light switch plates 24 often have screws 28 located above and below the light switch 26 that would prevent the indicator 12 from being placed flush upon the light switch plate 24. As such, it is also contemplated that the indicator may have a removal section 30 (FIG. 6) that forms an indent 32 (FIG. 7) that would be sized and configured to fit over a standard screw head, as demonstrated in FIG. 8.

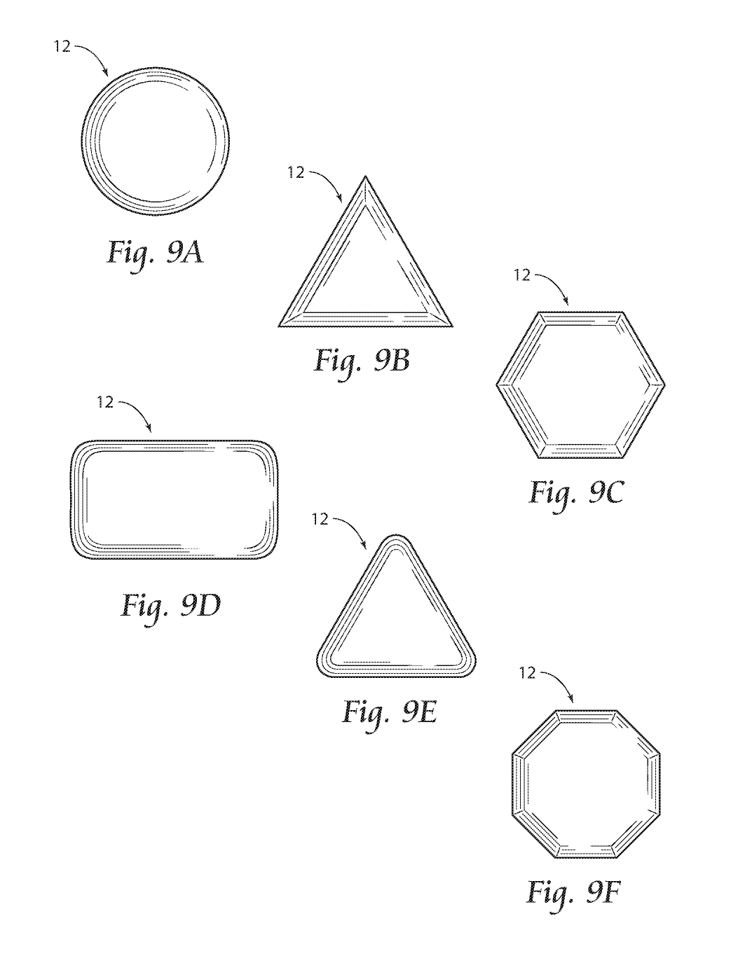

It should be understood that the light switch indicator 12 of the present invention can have further designs, if necessary or for aesthetic purposes. For example, FIGS. 9A-9F depict potential further shapes for the light switch indicator. It should be understood that these shapes are exemplary of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. A labeling kit for use with switch plates comprising:
a plurality of indicator tabs, each having a front side and a rear side, wherein each front side has one of several raised indicia thereon, and wherein each rear side has a depression sized to accommodate a screw head.

2. A method of labeling wall switches used to activate electrical devices comprising:
determining which electrical device is activated by a particular wall switch;
selecting a switch plate indicator tab bearing a marking corresponding to the electrical device; and
applying the selected tab to the switch plate of the particular wall switch.

3. The method of claim 2, wherein the selection step comprises selecting a tab having a marking that is raised from a front surface of the tab.

4. The method of claim 2, wherein the applying step is accomplished with the use of adhesive.

5. The method of claim 2, wherein the selecting step includes selecting a tab bearing a depression in a rear surface of the tab, and the applying step includes applying the tab over a screw head.

6. The method of claim 2, further comprising a removal step in which the tab has a dimension that permits finger removal of the tab.

7. A switch plate indicator tab comprising:
a front side bearing a raised indicator and a rear side bearing adhesive, said rear side also having a depression therein sized to accommodate a screw head; wherein the front side and the rear side are spaced apart such that the tab is raised from the switch plate.
